(19) United States
(12) Patent Application Publication
(10) Pub. No.: US 2024/0269547 A1
(43) Pub. Date: Aug. 15, 2024

(54) OMNIDIRECTIONAL FLOORING SYSTEM FOR VIRTUAL REALITY ENVIRONMENT

(71) Applicant: James William Blackford, Vancouver (CA)

(72) Inventor: James William Blackford, Vancouver (CA)

(21) Appl. No.: 18/438,544

(22) Filed: Feb. 12, 2024

Related U.S. Application Data
(60) Provisional application No. 63/484,234, filed on Feb. 10, 2023.

(51) Int. Cl. A63F 13/214; G06T 17/00

(52) U.S. Cl. CPC A63F 13/214; G06T 17/00; A63F 2300/8047

(57) ABSTRACT

A virtual reality flooring system that is configured to be operably coupled to a virtual reality game wherein the present invention includes a plurality of tile members that are movable in a X, Y and Z axis so as to maintain a user's position during execution of movements during a virtual reality environment. The present invention includes a base platform wherein the base platform has operably disposed therein a plurality of tile members arranged in a fixed grid. The tile members are operably coupled to a movement member and further include a sensor wherein the tile members are configured to move independently to a position to support a user's foot and provide engagement therewith during a movement. The tile members utilize a Z-axis movement to move from a first state to a second state with the user's foot.

### PRIORITY

This nonprovisional application claims priority based upon the following prior United States Provisional Patent Application entitled: Omnidirectional Flooring System for Virtual Reality Environment, Application No.: 63/484,234 filed Feb. 10, 2023, in the name of James William Blackford which is hereby incorporated by reference for all purposes.

### FIELD OF THE INVENTION

The present invention relates generally to simulated environments, more specifically but not by way of limitation, a flooring system to be utilized in conjunction with a virtual reality system wherein the flooring system of the present invention includes a plurality of omni-directional tile components.

### BACKGROUND

Virtual reality is a simulated three-dimensional environment that enables users to explore and interact with a virtual surrounding in a way that approximates reality, as it is perceived through the users' senses. The environment is created with computer hardware and software, although users might also need to wear devices such as helmets or goggles to interact with the environment. The more deeply users can immerse themselves in a virtual reality environment and block out their physical surroundings the more they are able to suspend their belief and accept it as real, even if it is fantastical in nature. The virtual reality industry has obstacles before realizing its vision of a totally immersive environment that enables users to engage multiple sensations in a way that approximates reality. However, the technology in the last decade has begun to provide a realistic sensory engagement and shows promise for business use in a number of industries. Virtual reality systems can vary significantly depending on their purpose and the technology used. Virtual reality environments are typically categorized into three categories. Non-immersive, which is a type of virtual reality that typically refers to a three-dimensional simulated environment that is accessed through a computer screen. The environment might also generate sound depending on the program and the user has some control over the virtual environment using a keyboard, mouse or other device but the environment does not directly interact with the user. A video game is a good example of non-immersive virtual reality.

The second category of virtual reality of Semi-immersive. This type of virtual reality offers a partial virtual experience that is accessed through a computer screen or some type of glasses or headset. It focuses primarily on the visual three-dimensional aspect of virtual reality and does not incorporate physical movement in the way that full immersion does. A common example of semi-immersive virtual reality is the flight simulator, which is used by airlines and militaries to train their pilots. The third category of virtual reality is fully immersive. This type of virtual reality delivers the greatest level of virtual reality, completely immersing the user in the simulated three-dimensional environment. The fully-immersive virtual reality environment incorporates sight, sound and, in some cases, touch. Users wear special equipment such as helmets, goggles or gloves and are able to fully interact with the environment. The environment might also incorporate such equipment as treadmills or stationary bicycles to provide users with the experience of moving through a three-dimensional space. Fully immersive virtual reality technology is a field still in its infancy, but it has made important advances into the gaming industry and to some extent the healthcare industry.

Augmented reality also is sometimes referred to as a type of virtual reality, although many would argue that it is a separate but related field. With augmented reality, virtual simulations are overlaid onto real-world environments in order to enhance or augment those environments. For example, a furniture retailer might provide an app that enables users to point their phones at a room and visualize what a new chair or table might look like in that setting. Another category that is sometimes considered a type of virtual reality is mixed-reality, which blends the physical and virtual worlds into a single space. Like augmented reality, however, mixed reality is more often considered a separate but related field. There is a growing consensus to group virtual reality, augmented reality and mixed reality under the umbrella term “extended reality,” which provides a tactic to reference all three, while still distinguishing among them.

Virtual reality is often associated with gaming because the industry has been at the forefront of the virtual reality effort, as evidenced by the popularity of virtual reality games. While gaming has adopted virtual reality technology, other areas and/or industries have begun to implement virtual reality technology. One example is training. Virtual reality makes it possible to train personnel safely, efficiently and cost-effectively. It can be especially beneficial to those in high-risk or highly specialized positions, such as firefighters, EMTs, police officers, soldiers, surgeons or other medical personnel. Another area that has begun to adopt virtual reality is education. Virtual reality offers educational institutions new methods for teaching and learning. It can provide students with intimate insights into environments that are typically inaccessible, while keeping them engaged in the learning process. Yet a further industry that is beginning to adopt virtual reality is healthcare. Virtual Reality has the potential to benefit individuals across the healthcare industry, including patients, practitioners and researchers. Still a further industry that could benefit from virtual reality is retail. Virtual reality has made advances into retail employing software applications that allow customers to try on clothes, decorate their homes, experiment with hair styles, test eye glasses and in general make more informed decisions about products and services. While virtual reality has made advances, there are still significant shortcomings in the field of creating an environment wherein the user feels comfortable with the simulated experience.

It is intended within the scope of the present invention to provide a flooring system that is utilized in a virtual reality environment wherein the flooring system comprises individual segment that move in an X, Y and Z axis independently of each other.

### SUMMARY OF THE INVENTION

It is the object of the present invention to provide a flooring system that facilitates a more interactive engagement with a virtual reality environment wherein the present invention includes an active surface on which the individual engaged in a virtual environment is superposed.

Another object of the present invention is to provide a virtual reality tile floor system that is operable to deliver an immersive experience in a virtual reality environment wherein the present invention includes a plurality of tiles that are adjacent each other.

A further object of the present invention is to provide a flooring system that facilitates a more interactive engagement with a virtual reality environment wherein the flooring system includes a plurality of tiles wherein each of the plurality of tiles are movable in an X, y and Z axis.

Still another object of the present invention is to provide a virtual reality tile floor system that is operable to deliver an immersive experience in a virtual reality environment wherein the plurality of tiles are operably coupled to a platform.

An additional object of the present invention is to provide a flooring system that facilitates a more interactive engagement with a virtual reality environment wherein the platform of the plurality of tiles includes sensors to detect movement of the user superposed thereon.

Yet a further object of the present invention is to provide a virtual reality tile floor system that is operable to deliver an immersive experience in a virtual reality environment wherein the tiles are operable to move in an opposite direction of the desired movement prior to engagement with the user's feet.

Another object of the present invention is to provide a flooring system that facilitates a more interactive engagement with a virtual reality environment wherein the present invention includes a support structure that is operably coupled to the torso of the user so as to maintain the user in a central location over the tile platform.

An alternate object of the present invention is to provide a virtual reality tile floor system that is operable to deliver an immersive experience in a virtual reality environment wherein the support structure assists in defining the user orientation with the virtual reality environment.

Still a further object of the present invention is to provide a flooring system that facilitates a more interactive engagement with a virtual reality environment wherein the tiles of the present invention are operably coupled to the sensors so as to provide pre-emptive movement thereof to anticipate the user's movement of their body and provide engagement therewith.

An additional object of the present invention is to provide a virtual reality tile floor system that is operable to deliver an immersive experience in a virtual reality environment wherein each adjacent tile has a one hundred and eighty degree Cycle phase shift so as to produce a smooth continuous movement for the user superposed thereon.

Yet a further object of the present invention is to provide a flooring system that facilitates a more interactive engagement with a virtual reality environment wherein adjacent tiles are configure to execute opposing vector movements.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an exemplary virtual reality environment with the flooring system of the present invention;

FIG. 2 is a top diagrammatic view of the present invention; and FIG. 3 is a side diagrammatic view of the tile members present invention; and

FIG. 4 is a side diagrammatic view a complete movement cycle for a single tile member of the present invention.

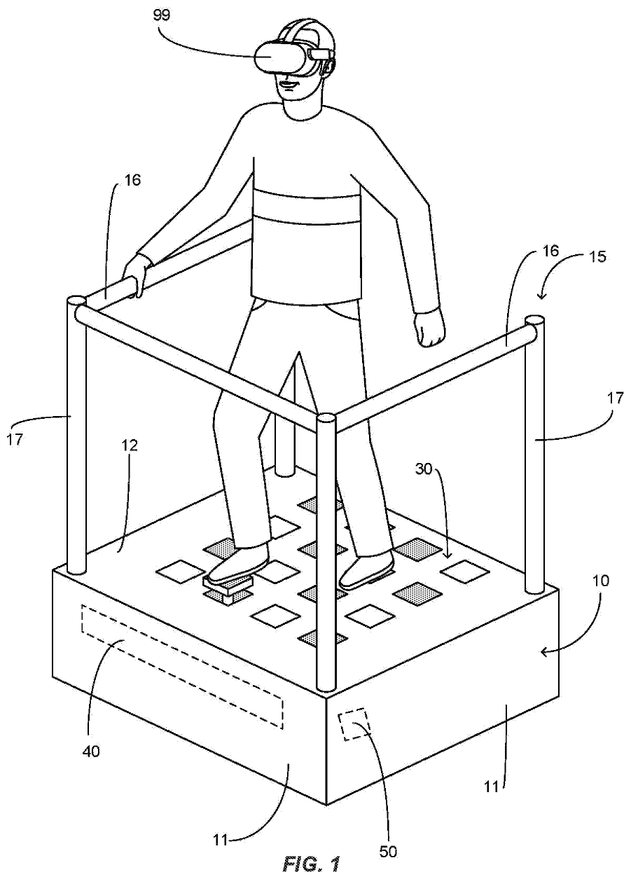

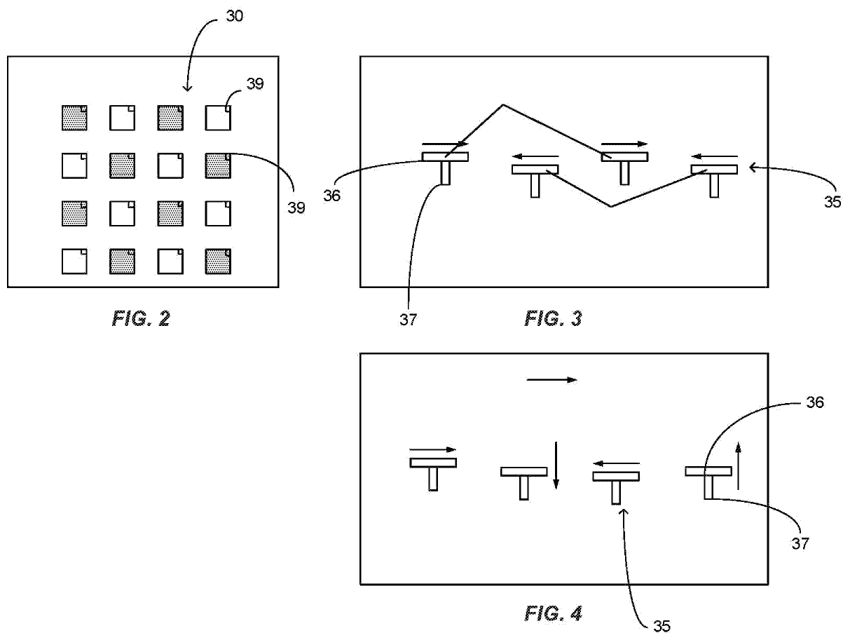

### DETAILED DESCRIPTION

Referring now to the drawings submitted herewith, wherein various elements depicted therein are not necessarily drawn to scale and wherein through the views and figures like elements are referenced with identical reference numerals, there is illustrated a virtual reality flooring system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic. Referring in particular to the Figures submitted herewith, the virtual reality flooring system 100 is operably coupled to a conventional virtual reality game that employs an exemplary headset 99. It should be understood within the scope of the present invention that the operable connection could be executed utilized conventional wireless or wired protocols. The virtual reality flooring system 100 includes a base platform 10. The base platform 10 includes wall members 11 and top member 12 that are integrally formed utilizing suitable techniques. The base platform 10 is manufactured from a rigid durable material such as but not limited to metal. While the base platform 10 is illustrated herein as being square in shape, it should be understood within the scope of the present invention that the base platform 10 could be provided in various alternate shapes and sizes. The base platform 10 includes a perimeter rail member 15 operably coupled to the top member 12. The perimeter rail member 15 includes horizontal members 16 and vertical member 17 that are operably coupled. The perimeter rail member 15 inhibits a user's ability to unintentionally traverse off of the top member 12. While a perimeter rail member 15 is illustrated herein, it is contemplated within the scope of the present invention that alternate elements could be employed to assist in maintaining a user superposed on the top member 12. By way of example but not limitation, the virtual reality flooring system 100 could employ an element that surroundably mounts to a user's torso and includes restraint members limiting the ability to move in a direction past a certain distance.

The top member 12 has operably coupled therein a tile assembly 30. The tile assembly 30 is operably coupled to the base platform 10 utilizing suitable durable techniques. The tile assembly 30 comprises of a plurality of tile members 35 that are operably disposed within a fixed grid so that when the tile members 35 are not engaged for a movement the user's feet are not engaged therewith. As is further discussed herein, the tile members 35 movement is defined to maintain a user's position in the center of the base platform 10 while performing actions such as walking or running. The tile members 35 are diagrammatically illustrated herein and it should be understood within the scope of the present invention that the adjacent tile members 35 border each other with little to no void therebetween during their static positions.

The tile members 35 include upper portion 36 and lower portion 37. Upper portion 36 of the tile member 35 is planar in manner being horizontally oriented so as to accept a user's foot superposed thereon. The lower portion 37 is perpendicular to the upper portion 36 and extends downward from the upper portion 36. The lower portion 37 of each tile member 35 is operably coupled to the movement member 40. The movement member 40 is disposed within the base platform 10 and is configured to provide all of the directional movements of the tile members 35 discussed herein. The movement member 40 employs various conventional mechanical elements to facilitate the three directional movement of each tile member 35. It should be understood within the scope of the present invention that the movement member 40 employs conventional elements such as but not limited to belts, chains, pulleys, track members and electric motors in various combinations to execute the three-dimensional movement of the tile members 35.

The tile members 35 are each equipped with sensors 39. Sensors 39 are mounted in the upper portion 36 of each tile member 35 and are configured to detect motion of the user's feet so as to position a tile member 35 in the correct position to permit execution of the motion being performed by the user. It should be understood within the scope of the present invention that the sensors 39 are conventional motion sensors 39 and are operably coupled to the controller 50. It should be further understood within the scope of the present invention that the sensors 39 could be mounted in alternate locations such as but not limited to the base platform 10. Controller 50 provides operational control of the virtual reality flooring system 100 and is operably coupled to the sensors 39, tile members 35 and movement member 40. The controller 50 includes the necessary electronics to receive, store, transmit and manipulate data. The controller 50 is operably coupled to the exemplary headset 99 and receives input therefrom that precipitates the required movements of the tile members 35 that allow the user to execute the desired motion while remaining proximate the center of the base platform 10.

The tile members 35 are movable in a X, Y and Z axis direction. All movements of the tile members 35 are operable to facilitate an ability of the user to execute a motion such as but not limited to walking or running while maintaining the user proximate the center of the top member 12. The Z axis motion of tile members 35 is utilized to engage and disengage the tile members 35 from the user's foot. The X axis movement and Y axis movement are utilized to allow the user to move their feet in the desired direction with the tile members 35 being engaged with the user's feet. When the tile members 35 are disengaged with the user's foot this state allows the tile members 35 to move in a required direction prior to moving to the state wherein the tile member 35 needs to be in position to engage the user's foot. Each tile member 35 has a one hundred and eighty degree Cycle phase shift from adjacent tile members 35 in order to produce smooth continuous movement of all of the tile members 35. FIG. 3 and FIG. 4 provide diagrams of the movements of the tile members 35 during the two states thereof, wherein the two states are disengaged with a user's foot and engaged with a user's foot.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the claims.

What is claimed is:

1. A virtual reality environment flooring system that is utilized in a virtual reality environment wherein the flooring system comprises:
a base platform, said base platform having a plurality of walls, said base platform having a top member operably coupled to said walls proximate an upper edge thereof;
a controller, said controller having electronics configured to receive, store, transmit and manipulate data, said controller configured to provide operation of the virtual reality environment flooring system;
a tile assembly, said tile assembly comprising a multitude of tile members, said tile members being arranged in a grid pattern, said tile members being adjacent each other, said tile members having an upper portion and a lower portion, said upper portion of said tile members being horizontal in orientation, said tile members being independently movable;
a movement member, said movement member disposed within said base platform, said movement member operably coupled to said lower portion of each of said tile members, said movement member configured to move said tile members in a first direction, a second direction and a third direction.

2. The virtual reality environment flooring system that is utilized in a virtual reality environment as recited in claim 1, and further including a user restraint member, said user restraint member operably coupled to said base platform, said user restraint member operable to assist a user maintain position within boundaries of the top member of the base platform.

3. The virtual reality environment flooring system that is utilized in a virtual reality environment as recited in claim 2, wherein the first direction is a Z axis movement, said first direction employed to facilitate engagement and disengagement with a user's foot.

4. The virtual reality environment flooring system that is utilized in a virtual reality environment as recited in claim 3, wherein said second direction is an X axis movement, wherein said second direction is employed to shift the user's foot in a desired direction.

5. The virtual reality environment flooring system that is utilized in a virtual reality environment as recited in claim 4, wherein said third direction is an Y axis movement, wherein said third direction is employed to shift the user's foot in a desired direction.

6. The virtual reality environment flooring system that is utilized in a virtual reality environment as recited in claim 5, wherein the tile members are either in a first state or a second state.

7. The virtual reality environment flooring system that is utilized in a virtual reality environment as recited in claim 6, wherein in said first state at least a portion of the tile members are disengaged with the user's foot to enable movement in an opposite direction of a desired movement of a user.

8. The virtual reality environment flooring system that is utilized in a virtual reality environment as recited in claim 7, wherein in said second state at least a portion of the tile members are engaged with the user's foot in order to support the user's foot during execution of the desired movement of the user.

9. The virtual reality environment flooring system that is utilized in a virtual reality environment as recited in claim 8, wherein each of the tile members has a movement of one-hundred-and-eighty-degree Cycle phase shift from adjacent tile members.

10. The virtual reality environment flooring system that is utilized in a virtual reality environment as recited in claim 9, wherein the first direction, second direction and third direction movement of the tile members are operable to maintain a user's position in a center area of the tile assembly.
